(19) United States
(12) Patent Application Publication
(10) Pub. No.: US 2008/0011225 A1
(43) Pub. Date: Jan. 17, 2008

(54) APPARATUS AND METHODS FOR CONTINUOUSLY DEPOSITING A PATTERN OF MATERIAL ONTO A SUBSTRATE

(76) Inventors: Donald J. McClure, Shoreview, MN (US); Jeffrey H. Tokie, Scandia, MN (US); Daniel H. Carlson, Arden Hills, MN (US); James N. Dobbs, Woodbury, MN (US); John T. Strand, Stillwater, MN (US); Ronald P. Swanson, Woodbury, MN (US)

Correspondence Address: 3M INNOVATIVE PROPERTIES COMPANY, PO BOX 33427, ST. PAUL, MN, 55133-3427, US

(21) Appl. No.: 11/456,687

(22) Filed: Jul. 11, 2006

(51) Int. Cl. B05C 1/00; B05C 11/11

(52) U.S. Cl. 118/244; 118/504

(57) ABSTRACT

A pattern of material is continuously deposited onto a substrate. The substrate and a mask are continuously brought together over a portion of a drum where a deposition source emits material. The mask includes apertures that form a pattern, and the material from the deposition source passes through the pattern of the mask and collects onto the substrate to form the pattern of material. The elongation and the transverse position of the substrate and the mask may be controlled. Pattern elements of the substrate and of the mask may be sensed in order to adjust the elongation and/or the transverse position of the substrate and/or mask to maintain a precise registration. Furthermore, the apertures may have a least dimension on the order of 100 microns or less to thereby create features on the substrate having least dimensions on the order of 100 microns or less.

### RELATED PATENT APPLICATION

This application claims priority to U.S. patent application Ser. No. 11/179,418 filed on Jul. 12, 2005 and incorporated herein in its entirety.

### TECHNICAL FIELD

The present invention is related to depositing a pattern of material onto a substrate. More particularly, the present invention is related to depositing a pattern of material by continuously moving the substrate and a mask defining the pattern through a deposition area.

### BACKGROUND

Patterns of material may be formed on a substrate by emitting material from a deposition source in a direction toward the substrate. The material is deposited in a particular pattern onto the substrate by having a mask located between the deposition source and the substrate. The mask includes apertures that define the pattern, and only the deposition material passing through the apertures reaches the substrate so that the material is deposited in a pattern.

Such patterns may be deposited on a substrate for various purposes. As one example, circuitry may be formed on the substrate by depositing material in various patterns. For example, conductive traces, like metallization patterns, can be formed on flexible dielectrics for various uses, including encoding information on flexible tab circuits installed on a thermal ink jet head.

Conventional patterned deposition of material through a mask onto a substrate is done in a step and repeat fashion. The substrate moves forward by a pre-defined amount and stops with the mask being in a fixed and known position relative to the substrate. Then, the deposition source emits the material through the mask to form the pattern. The substrate then moves again by a pre-defined amount and stops and the deposition occurs again. This is repeated to form multiple instances of a given pattern of material onto a roll of substrate material. Each pattern of material on the substrate may be exposed to another downstream mask and deposition source to form additional layers of patterned material.

The step and repeat procedure, while effective at accurately producing multiple instances of the pattern with a relatively fine feature size, has the drawback of being relatively inefficient. The time spent moving the substrate and precisely aligning the mask and substrate, which is a significant amount of time relative to the total time to deposit the layer, is time spent not depositing material. Therefore, the step and repeat procedure may not achieve a rate of production that is desirable.

### SUMMARY

Embodiments of the present invention address these issues and others by providing apparatus and methods that continuously deposit material onto the substrate, rather than following a step and repeat routine. Because material is being deposited continuously while the substrate is in motion, the time spent moving the substrate is not wasted.

One embodiment is an apparatus for continuously depositing a pattern of material on a substrate. The apparatus includes a substrate delivery roller from which the substrate is delivered and a first substrate receiving roller upon which the substrate is received such that the substrate extends from the substrate delivery roller to the substrate receiving roller, and the substrate continuously passes from the substrate delivery roller to the substrate receiving roller. The apparatus further includes a first mask containing apertures defining a first pattern, wherein one or more of the apertures have a least dimension of 100 microns or less. The apparatus further includes a first mask delivery roller from which the first mask is delivered and a first mask receiving roller upon which the first mask is received such that the mask extends from the mask delivery roller to the mask receiving roller, and the first mask continuously passes from the first mask delivery roller to the first mask receiving roller. A first drum is included upon which the substrate and first mask come into contact over a portion of the circumference of the first drum between delivery from the substrate and mask delivery rollers and reception onto the substrate and mask receiving rollers, and the first drum continuously rotates. A first deposition source is positioned to continuously direct a first deposition material toward the portion of the first mask that is over the portion of the circumference of the first drum such that at least a portion of the first deposition material passes through the apertures of the first mask to continuously deposit the first pattern of the first material on the substrate.

Another embodiment is an apparatus for continuously depositing a pattern of material on a substrate that includes a substrate delivery roller from which the substrate is delivered and a first substrate receiving roller upon which the substrate is received such that the substrate extends from the substrate delivery roller to the substrate receiving roller, where the substrate continuously passes from the substrate delivery roller to the substrate receiving roller. The apparatus further includes a first mask containing apertures defining a first pattern, a first mask delivery roller from which the first mask is delivered, and a first mask receiving roller upon which the first mask is received such that the mask extends from the mask delivery roller to the mask receiving roller, where the first mask continuously passes from the first mask delivery roller to the first mask receiving roller. The apparatus further includes a first drum upon which the substrate and first polymeric mask come into contact over a portion of the circumference of the first drum between delivery from the substrate and mask delivery roller and reception onto the substrate and mask receiving rollers, where the first drum continuously rotates. Additionally, the apparatus includes a first deposition source positioned to continuously direct first deposition material toward the portion of the first mask that is over the portion of the circumference of the first drum such that at least a portion of the first deposition material passes through the apertures of the first mask to continuously deposit the first pattern of the first material on the substrate. A first substrate elongation control system maintains a pre-determined elongation of the substrate in the direction of delivery from the substrate delivery roller to the first drum as the substrate comes into contact over a portion of the circumference of the first drum, and a first mask elongation control system maintains a pre-determined elongation of the first mask in the direction of delivery from the first mask delivery roller to the first drum as the first mask comes into contact over a portion of the circumference of the first drum. A first substrate transverse position control system includes a web guide that adjusts the transverse position of the substrate to a pre-determined transverse location on the first drum, and a first mask transverse position control system includes a web guide that adjusts the transverse position of the first mask to a pre-determined transverse location on the first drum.

Yet another embodiment is a method of continuously depositing material that involves continuously delivering a substrate from a substrate delivery roller while continuously receiving the substrate onto a substrate receiving roller, wherein the substrate passes over a portion of a circumference of a first drum when between the substrate delivery roller and the substrate receiving roller. The method further involves while continuously delivering and receiving the substrate, continuously delivering a first mask from a first mask delivery roller while continuously receiving the first mask onto a first mask receiving roller, wherein the first mask passes over a portion of a circumference of the first drum when between the first mask delivery roller and the first mask receiving roller and wherein the first mask has a plurality of apertures forming a first pattern and at least a portion of the apertures have a least dimension of 100 microns or less. Additionally, the method involves while continuously delivering and receiving the substrate and the first mask, continuously directing a first deposition material from a first deposition source toward a portion of the first mask that is over the portion of the circumference of the first drum such that the first pattern of first material is deposited on the substrate.

### DESCRIPTION OF THE DRAWINGS

FIG. 1 shows an embodiment of an apparatus providing a first stage of a deposition process with an internal drum deposition, without pre-patterned fiducial elements, and with a roll-to-roll mask.

FIG. 2 shows an embodiment of an apparatus providing a first stage of a deposition process with an internal drum deposition, without pre-patterned fiducial elements, and with a continuous-loop mask.

FIG. 3 shows an embodiment of an apparatus providing a first stage of a deposition process with an external drum deposition, without pre-patterned fiducial elements, and with a roll-to-roll mask.

FIG. 4 shows an embodiment of an apparatus providing a first stage of a deposition process with an internal drum deposition, with pre-patterned fiducial elements, and with a roll-to-roll mask.

FIG. 5 shows an embodiment of an apparatus providing a first stage of a deposition process with an external drum deposition, without pre-patterned fiducial elements but with the fiducial patterning occurring in advance of the external drum deposition, and with a roll-to-roll mask.

FIG. 6 shows an embodiment of an apparatus providing a second stage of a deposition process with an internal deposition, and with a roll-to-roll mask.

FIG. 7 shows an illustrative rotary motor and velocity/position control system schematic for controlling the longitudinal web position for various embodiments.

FIG. 8 shows an illustrative guide motor control system schematic for controlling the lateral web position for various embodiments.

FIG. 9 shows a web fiducial registration control system schematic for maintaining proper registration of the two webs for various embodiments.

FIG. 10 shows an illustrative control system interface for the fiducial registration sensors of an embodiment of an apparatus providing a second stage of a deposition process.

FIG. 11 shows a control loop utilized by the illustrative control system interface of FIG. 10.

FIG. 12 shows an illustrative pattern of fiducial elements utilized on the mask and/or substrate for sensing both the relative lateral and longitudinal positions of each.

FIG. 13 shows a view of an illustrative sensing system for sensing both the lateral and longitudinal web position.

FIG. 14 shows a view of an illustrative sensing system for sensing both the lateral and longitudinal web position.

### DETAILED DESCRIPTION

Embodiments of the present invention provide for the continuous deposition of material onto a substrate in a pattern defined by a mask. The continuous deposition is provided by continuously moving a substrate and a mask through a deposition area provided by a deposition source and drum.

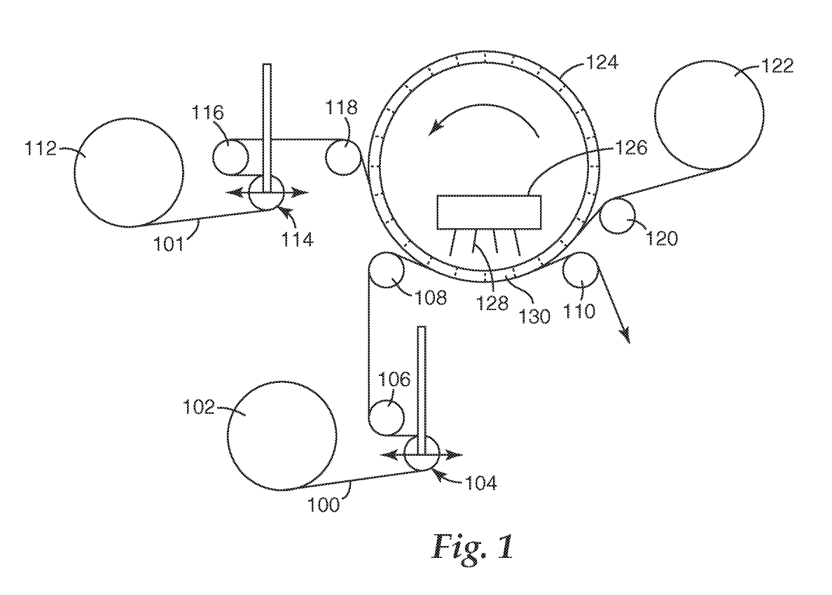

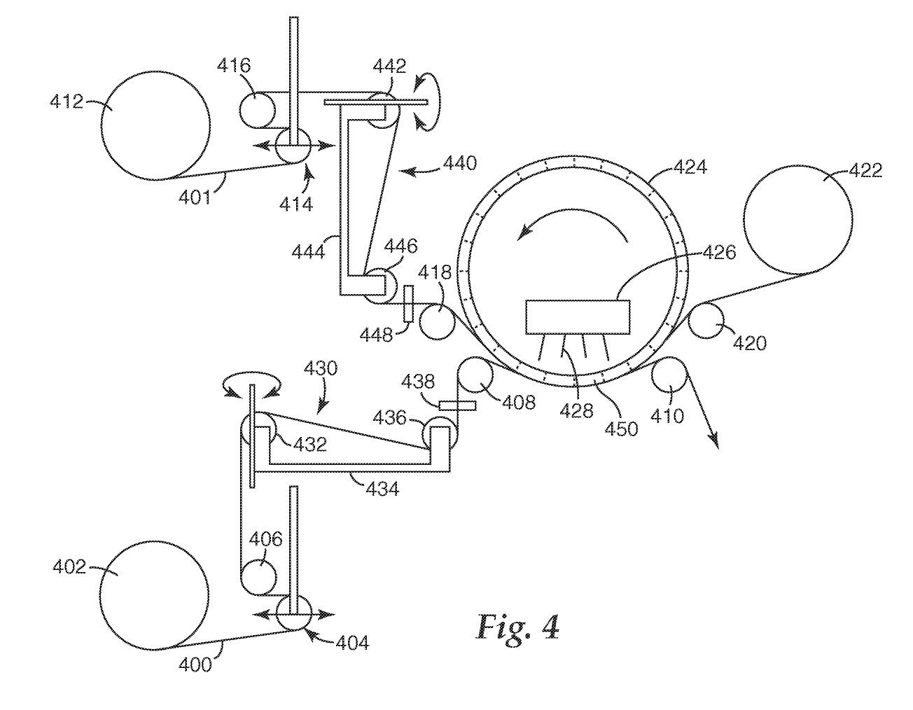

FIG. 1 shows one illustrative embodiment of an apparatus and resulting method that establish one stage for depositing a pattern of material continuously onto a substrate. In this particular embodiment, this first stage is being used to deposit pattern elements known as fiducials onto the substrate 100, where these fiducials may then be used in subsequent stages to properly register the substrate with a mask of the subsequent stage, where the precision of such registration is on the order of microns as discussed below with reference to FIG. 4. These fiducials are applied by depositing material through a mask 101 that includes apertures that provide for the pattern of fiducials. In addition to the fiducials, a first layer of circuitry may also be deposited where that first layer is the same material as that being deposited for the fiducials.

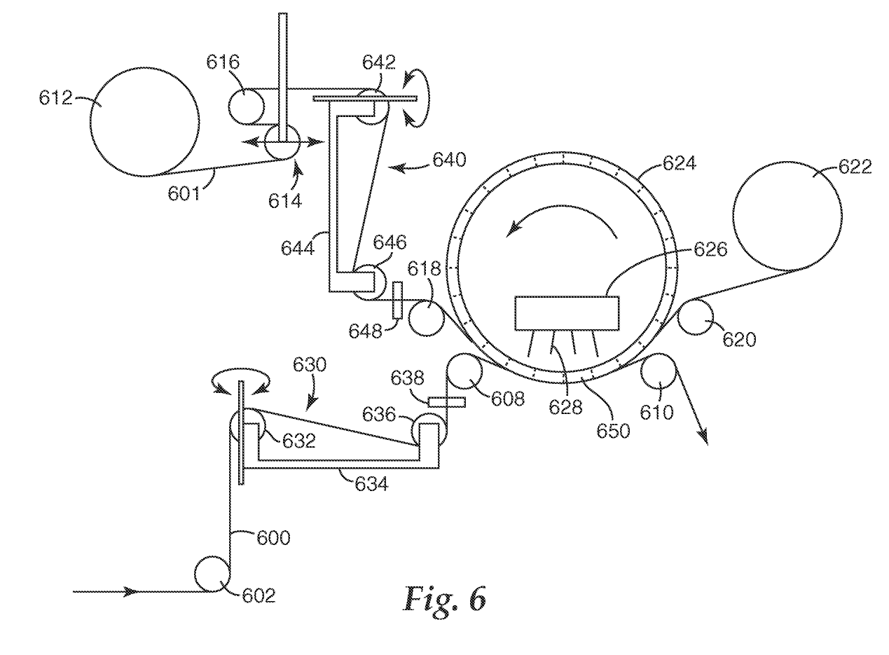

The substrate 100 begins on a roll of a substrate unwind reel 102 which serves as a delivery roller for the substrate 100 to the remainder of the apparatus of this first deposition stage. The substrate 100 is continuously pulled from the reel 102, through a dancer 104, over a tension load cell 106 by a precision drive roller 108. The substrate 100 is pulled tightly over a portion of a circumference of a rotating drum 124 and onto another receiving roller 110 for the substrate 100. The substrate 100 exits the receiving roller 110 and is either pulled into a subsequent deposition state, discussed below in relation to FIG. 6, or is rewound onto a substrate rewind reel.

The dancer 104 and tension load cell 106 are utilized to achieve a pre-determined and controlled elongation, or stretch, of the substrate 100 in the direction of delivery to the drum 124 for a given speed of the substrate 100. The speed of the substrate 100 is dictated by the speed of the precision drive roller 108, which is synchronized closely to the speed of the drum 124, which itself has a precision drive mechanism. The speed chosen is a matter of design choice, based on whether the pre-determined elongation and proper thickness of deposition can be achieved.

As is known in the art, the dancer 104 utilizes a rotary sensor to provide feed back to control the speed of the unwind reel 102, as a tensioning force is applied to the substrate 100 by an actuator of the dancer 104. The tension load cell 106 provides a force reading that can be used to trim the force applied by the actuator of the dancer 104. A control system applies logic based on the readings from the tension load cell 106 and the speed of the drum 124 to make a slight alteration of the speed of the drive roller 108 to control the elongation of the substrate 100 as desired.

The mask 101 begins on a roll of a mask unwind reel 112 which serves as a delivery roller for the mask 101 to the remainder of the apparatus of this first deposition stage. The mask 101 is continuously pulled from the reel 112, through a dancer 114, over a tension load cell 116 by a precision drive roller 118. The mask 101 is pulled tightly over the portion of a circumference of a rotating drum 124 where the substrate is also pulled to thereby bring the mask 101 into contact with the substrate 100 and is further pulled onto a receiving roller 120 for the mask 101. The mask 101 exits the receiving roller 120 and is rewound onto a substrate rewind reel 122.

As with the substrate 100, the dancer 114 and tension load cell 116 are utilized to achieve a pre-determined and controlled elongation, or stretch, of the mask 101 in the direction of delivery to the drum 124 for a given speed of the mask 101. The speed of the mask 101 is further dictated by the speed of the precision drive roller 118, which is also synchronized closely to the speed of the drum 124. As discussed above in relation to the substrate 100, the speed chosen is a matter of design choice, based on whether the pre-determined elongation and proper thickness of deposition can be achieved.

As with the dancer 104, the dancer 114 utilizes a rotary sensor to provide feed back to the mask unwind reel 112 as a tensioning force is applied to the mask 101 by an actuator of the dancer 114. The tension load cell 116 provides a force reading that can be used to trim the force applied by the actuator of the dancer 114. A control system applies logic based on the readings from the tension load cell 116 and speed of the drum 124 to make a slight alteration of the speed of the drive roller 118 to control the elongation of the mask 101 as desired.

This particular embodiment includes a deposition source 126 that is located internally within the drum 124. Therefore, it is necessary to have the mask 101 be in direct contact with the drum 124 while the substrate 100 is in direct contact with the mask 101 and separated from the drum 124 by the mask 101. The drum 124 has large apertures 130 designed into the roll to accommodate material flux towards the mask with little restriction and that are spaced around its circumference to allow deposition material 128 emitted from the deposition source 126 to pass through the drum 124 and reach the mask 101. The apertures in the mask then allow the deposition material 128 to reach the substrate 100 to thereby form the pattern on the substrate 100.

The deposition source 126 may be one of various types depending upon the type of deposition and type of deposition material desired. For example, the deposition source 126 may be a sputtering cathode or magnetron sputtering cathode for purposes of depositing metallic or conductive metal oxide materials. As another example, the deposition source 126 may be an evaporation source for purposes of depositing metallic or conductive metal oxide materials.

The configuration of the drum 124, deposition source 126, mask 101, and substrate 100 may be such that the mask 101 and substrate 100 pass on the bottom of the drum with the deposition source 126 emitting the deposition material downward. However, it will be appreciated that the mask 101 and substrate 100 may alternatively be positioned so as to pass over the top of the drum 124 while the deposition source 126 emits the deposition material upward. This alternative is particularly the case where an evaporation source is used.

The substrate 100 and the mask 101 may also be one of various types of materials. Examples include polymeric materials, such as polyester (both PET and PEN), polyimide, polycarbonate, or polystyrene, metal foil materials, such as, stainless steel, other steels, aluminum, copper, or paper or woven or nonwoven fabric materials, all of the above with or without coated surfaces. However, utilizing a material with high elasticity, such as a polymeric material, for the substrate and mask allows for precision control of the elongation and for precision registration, as discussed below in relation to FIG. 4, such that the feature size can be made very small. The least dimension of the apertures in a polymeric mask may be on the order of microns, ranging from 100 microns down to 10 microns. Therefore, the corresponding feature that is deposited onto the substrate may have a least dimension that is also on the order of microns, also ranging from 100 microns down to 10 microns. Therefore, the density of the circuitry can be made very high, allowing for high-resolution, small footprint conductive traces, for example, to be generated in high rates of production through this continuous deposition process. It should be appreciated that if the aspect ratio of a trace is large it may be necessary to deposit the trace by passing the web through two or more deposition stations with two or more successive depositions through offset shadow masks since the aspect ratio of the mask apertures are limited in length of opening before affecting the dimensional stability of the aperture in the polymeric mask. Additional details on fabricating polymer aperture masks related to this embodiment are further described U.S. Pat. No. 6,897,164 (Baude et al.), incorporated herein by reference.

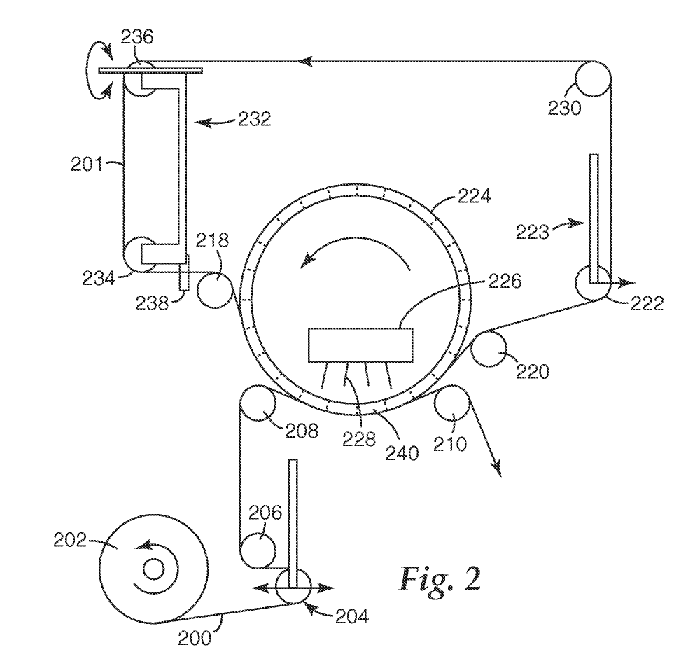

FIG. 2 shows an embodiment like that of FIG. 1 except that the mask is not a roll-to-roll configuration but is instead a continuous loop. Here, the substrate 200 unwinds from reel 202, passed through dancer 204 and over load cell 206 and is pulled by drive roller 208. The substrate 200 passes over the portion of the circumference of the drum 224 and is pulled over receiving roller 210 and then proceeds to the next deposition stage or is rewound onto a rewind reel. Thus, the elongation and speed of the substrate 200 is being controlled as in FIG. 1. Additionally, the deposition source 226 emits material 228 through apertures 240 of the drum 224 and the material reaches a mask 201 and passes through apertures in the mask 201 to reach the substrate 200 as happens in FIG. 1.

However, the mask 201 is a continuous loop that passes from a tension load cell 234 which is a roller of a web guide 232 and is pulled by drive roller 218 as it passes by a sensor 238. The mask 201 passes over the portion of the circumference of the drum 224 and is pulled away over receiving roller 220. The mask 201 then reaches another receiving roller 222 that is a roller of a tensioner 223 and routes the mask 201 to subsequent receiving roller(s) 230 that then route the mask 201 back to a roller 236 of the web guide 232. In this configuration, the elongation and speed of the mask 201 continues to be controlled by adjusting the force applied by an actuator of the tensioner 223 and the speed of the drive roller 218 based on readings from the tension load cell 234, and the lateral alignment of the mask 201 is also controlled by the web guide 232, where such a web guide is discussed in more detail below in relation to FIG. 4. However, the mask 201 continuously loops so as to be re-used. Eventually, the mask 201 must be replaced due to build-up of deposition material 228 onto the mask.

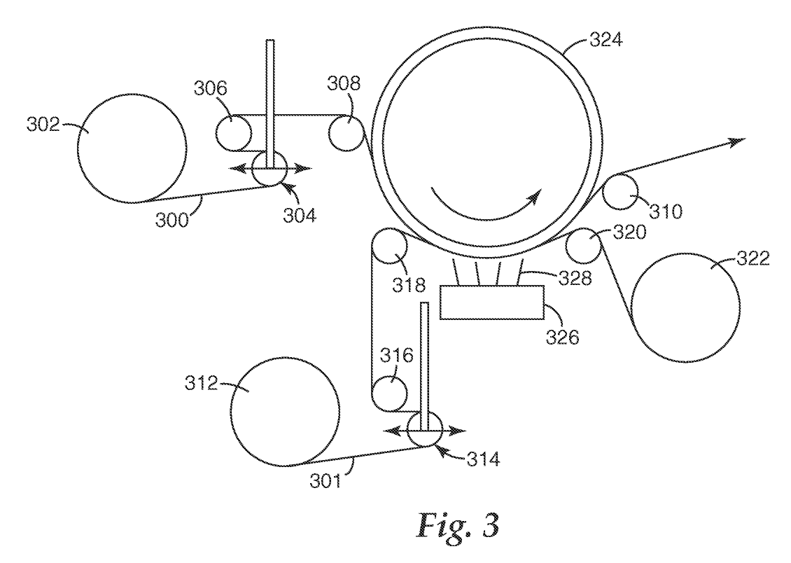

While FIG. 2 shows the configuration like that of FIG. 1 except for the continuously looping mask 201, it will be appreciated that the continuously looping mask 201 as shown in FIG. 2 is equally applicable to the other configurations discussed below in FIGS. 3-6.

FIG. 3 shows an embodiment like that of FIG. 1 except that the deposition source 326 is located outside of the drum 324. Here, the substrate 300 unwinds from reel 302, passes through dancer 304 and over load cell 306 and is pulled by drive roller 308. The substrate 300 passes over the portion of the circumference of the drum 324 and is directed further over receiving roller 310 and then proceeds to the next deposition stage or is rewound onto a rewind reel. Thus, the elongation and speed of the substrate 300 is being controlled as in FIG. 1. Additionally, as happens in FIG. 1, the mask 301 unwinds from reel 312, passes through dancer 314 and over load cell 316 and is pulled by drive roller 318. The mask 301 passes over the portion of the circumference of the drum 324 and is directed further over receiving roller 320 and then is rewound onto a rewind reel 322. Thus, the elongation and speed of the mask 301 is also being controlled as in FIG. 1.

However, the deposition source 326 is located externally of the drum 324 such that the deposition material 328 does not need to pass through the drum 324 prior to reaching the mask 301 and substrate 300. Therefore, the drum 324 need not necessarily include apertures. Additionally, the substrate 300 is in direct contact with the drum 324 while the mask 301 is in direct contact with the substrate 300 with the substrate 300 being positioned between the mask 301 and the drum 324.

While FIG. 3 shows the configuration like that of FIG. 1 except for the deposition source 326 being located externally of the drum 324, it will be appreciated that the external location of the deposition source 326 as shown in FIG. 3 is equally applicable to the other configurations including those of FIG. 2, and FIGS. 4-6.

FIG. 4 shows an embodiment like that of FIG. 1 except that the substrate 400 already has the pattern elements deposited or otherwise formed thereon. Since the pattern elements are already in place, precision registration as discussed below may be maintained between the substrate 400 and the mask 401 and features of the circuitry may be deposited during this phase without also simultaneously depositing fiducials of the same material.

The pattern elements may be pre-formed onto the substrate in one of many various ways which also apply to depositing such pattern elements onto the mask as described in any of these examples of FIGS. 1-6. Examples of how the pattern elements may be pre-formed onto the substrate and mask include sputtering, vapor deposition, laser ablation, laser marking, chemical milling, chemical etching, embossing, scratching, and printing.

In the embodiment of FIG. 4, the substrate 400 unwinds from reel 402, passes through dancer 404 and over load cell 406 and is pulled by drive roller 408. The substrate 400 passes over the portion of the circumference of the drum 424 and is directed further over receiving roller 410 and then proceeds to the next deposition stage or is rewound onto a rewind reel. Thus, the elongation and speed of the substrate 400 is being controlled as in FIG. 1. Additionally, as happens in FIG. 1, the mask 401 unwinds from reel 412, passes through dancer 414 and over load cell 416 and is pulled by drive roller 418. The mask 401 passes over the portion of the circumference of the drum 424 and is directed further over receiving roller 420 and then is rewound onto a rewind reel 422. Thus, the elongation and speed of the mask 401 is also being controlled as in FIG. 1.

However, there is additional control of the elongation and speed based on sensing the fiducials of both the substrate 400 and the mask 401 to maintain the substrate 400 and mask 401 in proper registration to within a tolerance of ½ of the smallest feature dimension (less than 100 microns; less than 50 microns; or even less than 25 microns) in the direction of delivery to the drum 424. Sensor 438 senses the fiducials on the substrate 400 while sensor 448 senses the fiducials on the mask 401. The relative speed between the substrate 400 and mask 401 may be adjusted via the drive rollers 408 and 418 respectively to compensate for the substrate 400 either leading or lagging the mask 401.

Furthermore, between the load cell 406 and the drive roller 408 for the substrate 400, a precision web guide 430 receives the substrate 400 and controls the transverse position of the substrate based on the sensor 438, sensing the fiducials to determine the transverse position. Moving webs have a tendency to move transversely on the rollers, but in most instances, the transverse position must be maintained within a precise tolerance of at least ½ of the smallest feature dimension (less than 100 microns; less than 50 microns; or even less than 25 microns) at the drum 424, so the web guide 430 adjusts the transverse position of the substrate 400. The web guide 430 includes a first roller 432, a frame 434, and a second roller 436. The frame 434 may be pivoted into and out of the page as shown at a pivot point at the edge of first roller 432 in order to guide the substrate 400 and change its transverse position on driver roller 408, and hence on drum 424. More details about a precision web guide suitable for this purpose can be found in U.S. Patent Application Publication No. 2005/0109811 (Swanson et al.), incorporated herein by reference.

Similarly for the mask 401, between the load cell 416 and the drive roller 418, a precision web guide 440 receives the mask 401 and controls the transverse position of the mask 401 based on the sensor 448 sensing the fiducials to determine the transverse position. The transverse position of the mask 401 must also be within a precise tolerance at the drum 424, so the web guide 440 adjusts the transverse position of the mask 401. The web guide 440 includes a first roller 442, a frame 444, and a second roller 446. The frame 444 may be pivoted into and out of the page as shown at a pivot point at the edge of first roller 442 in order to guide the mask 401 and change its transverse position on driver roller 418, and hence on drum 424.

A transverse position control system can be used in conjunction with or can be used independently of an elongation control system. Similarly, an elongation control system can be used in conjunction with or can be used independently of a transverse position control system.

As in FIG. 1, the deposition source 426 within the drum 424 emits deposition material 428 through apertures 450 of the drum 424 to reach the mask 401 and substrate 400 over the portion of the circumference of the drum 424. While FIG. 4 has been related to FIG. 1 in terms of this configuration being used as an initial deposition phase, it will be appreciated that the configuration of FIG. 4 may also be used as subsequent phases for situations where the substrate 400 is not proceeding directly from the preceding deposition phase, but has instead been rewound from the preceding phase and then introduced to this subsequent phase from the unwind reel 402.

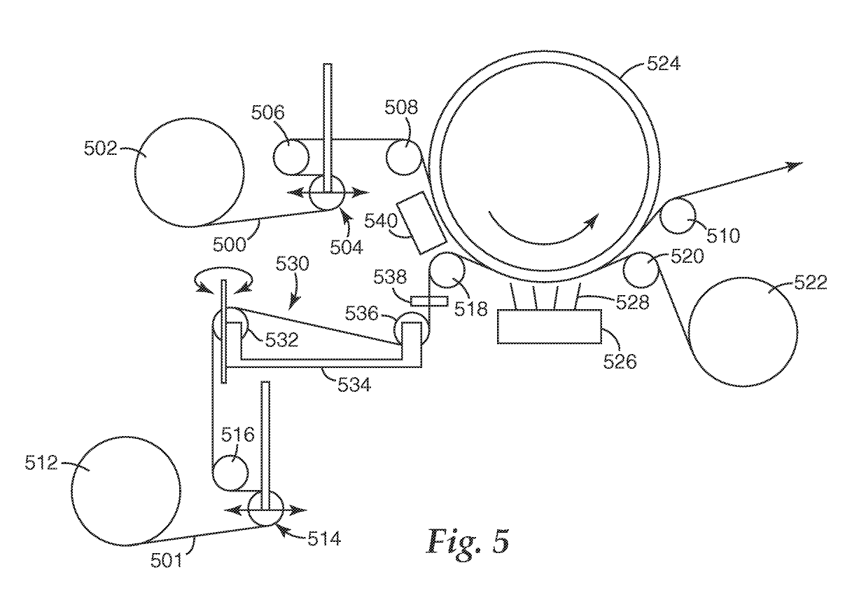

FIG. 5 shows an embodiment like that of FIG. 3 except that the substrate 500 is provided with pattern elements or fiducials using a fiducial deposition process 540. The fiducial deposition process 540 applies the fiducials to the substrate 500 at a point where the substrate 500 has come into contact with the circumference of the drum 524 but prior to the point where the mask 501 reaches the drum. Since the pattern elements are already in place at the drum 524, precision registration may be maintained between the substrate 500 and the mask 501 and features of the circuitry may be deposited during this phase without also simultaneously depositing fiducials of the same material. Examples of how the pattern elements may be pre-formed onto the substrate by the fiducial deposition process 540 include sputtering, vapor deposition, laser ablation or laser marking, chemical milling, chemical etching, embossing, scratching, and printing.

In the embodiment of FIG. 5, the substrate 500 unwinds from reel 502, passes through dancer 504 and over load cell 506 and is pulled by drive roller 508. The substrate 500 passes over the portion of the circumference of the drum 524 including the portion where the fiducial process 540 is aimed, is directed further over receiving roller 510, and then proceeds to the next deposition stage or is rewound onto a rewind reel. Thus, the elongation and speed of the substrate 500 is being controlled as in FIG. 3. Additionally, as happens in FIG. 3, the mask 501 unwinds from reel 512, passes through dancer 514 and over load cell 516 and is pulled by drive roller 518. The mask 501 passes over the portion of the circumference of the drum 524 and is directed further over receiving roller 520 and then is rewound onto a rewind reel 522. Thus, the elongation and speed of the mask 501 is also being controlled as in FIG. 3.

However, there is additional control of the elongation and speed based on sensing the fiducials of the mask 501 using sensor 538 to maintain the mask 501 in proper registration in the direction of delivery to the drum 524 with the fiducial patterning process 540. The relative speed of the mask 501 may be adjusted via the drive roller 518 to compensate for the mask 501 either leading or lagging the fiducial patterning process 540.

Furthermore, between the load cell 516 and the drive roller 518, a precision web guide 530 controls within a precise tolerance the transverse position of the mask 501 based on the sensor 538 sensing fiducials on the mask 501 to determine the transverse position. The web guide 530 includes a first roller 532, a frame 534, and a second roller 536. The frame 534 may be pivoted into and out of the page as shown at a pivot point at the edge of first roller 532 in order to guide the mask 501 and change its transverse position on driver roller 518, and hence on drum 524.

As in FIG. 3, the deposition source 526 located externally of the drum 524 emits deposition material 528 to reach the mask 501 and substrate 500 over the portion of the circumference of the drum 524.

FIG. 6 shows an embodiment like that of FIG. 4 except that the substrate 600 is being delivered directly from a preceding phase as opposed to being delivered from an unwind reel. As in FIG. 4, since the fiducial pattern elements are already in place, precision registration may be maintained between the substrate 600 and the mask 601 and features of the circuitry may be deposited during this phase without also simultaneously depositing fiducials of the same material.

In the embodiment of FIG. 6, the substrate 600 is received from the preceding phase directly at a tension load cell 602 and is pulled by drive roller 608. The substrate 600 passes over the portion of the circumference of the drum 624 and is directed further over receiving roller 610 and then proceeds to the next deposition stage or is rewound onto a rewind reel. There is no dancer for the substrate 600 for this phase, so the elongation and speed of the substrate 600 is being controlled by sensing the substrate 600 tension at load cell 602 and slightly altering the speed of drive roller 608 and drum 624. Further minute adjustments to substrate 600 elongation can be made by adjusting the relative speed between drive roller 608 and drum 624. Additionally, as happens in FIG. 4, the mask 601 unwinds from reel 612, passes through dancer 614 and over load cell 616 and is pulled by drive roller 618. The mask 601 passes over the portion of the circumference of the drum 624 and is directed further over receiving roller 620 and then is rewound onto a rewind reel 622. Thus, the elongation and speed of the mask 601 is also being controlled as in FIG. 4.

There is additional control of the elongation and speed based on sensing the fiducials of both the substrate 600 and the mask 601 to maintain the substrate 600 and mask 601 in proper registration in the direction of delivery to the drum 624. Sensor 638 senses the fiducials on the substrate 600 while sensor 648 senses the fiducials on the mask 601. The relative speed between the substrate 600 and mask 601 may be adjusted via the drive rollers 608 and 618 respectively to compensate for the substrate 600 either leading or lagging the mask 601.

Furthermore, between the load cell 602 and the drive roller 608 for the substrate 600, a precision web guide 630 receives the substrate 600 and controls the transverse position of the substrate based on the sensor 638 sensing the fiducials to determine the transverse position. The web guide 630 includes a first roller 632, a frame 634, and a second roller 636. The frame 634 may be pivoted into and out of the page as shown at a pivot point at the edge of first roller 632 in order to guide the substrate 600 and change its transverse position on driver roller 608, and hence on drum 624.

Similarly for the mask 601, between the load cell 616 and the drive roller 618, a precision web guide 640 receives the mask 601 and controls the transverse position of the mask 601 based on the sensor 648 sensing the fiducials to determine the transverse position. The web guide 640 includes a first roller 642, a frame 644, and a second roller 646. The frame 644 may be pivoted into and out of the page as shown at a pivot point at the edge of first roller 642 in order to guide the mask 601 and change its transverse position on driver roller 618, and hence on drum 624.

As in FIG. 4, the deposition source 626 within the drum 624 emits deposition material 628 through apertures 650 of the drum 624 to reach the mask 601 and substrate 600 over the portion of the circumference of the drum 624.

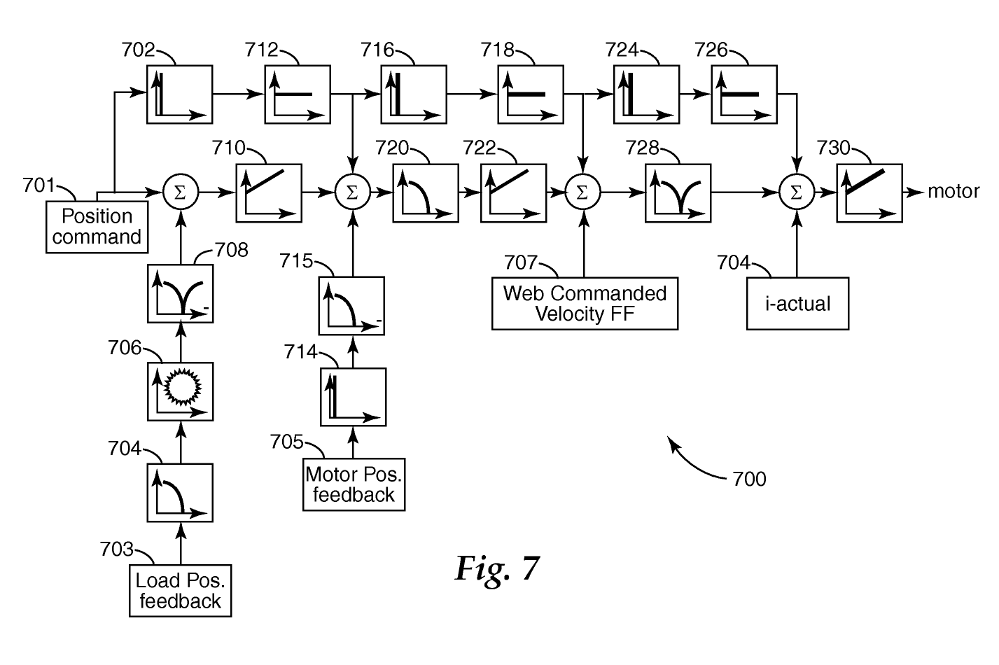

FIG. 7 shows an illustrative rotary motor position and velocity control system 700 wherein one of the systems 700 may be used to control the position, velocity and torque applied to each drive roller and drum. The control system 700 receives a position command 701 as input, and this command originates from a trajectory generator as can be appreciated from one skilled in the art of motion control. This command is provided to a position feed forward operation 702 which then outputs the position feed forward signal to a feed forward gain control operation 712.

The position command 701 is also summed with another signal that is based on a load position feed back signal 703 being provided to a low pass filter operation 704. The load position feed back signal 703 is received on the basis of a high precision rotary sensor mounted directly on a drive roller or drum. The low pass filter operation 704 provides an output to observers 706 that use other internal signals to generate an output that is applied to a feedback filtering operation 708 to provide the signal that is negatively summed with the position command 701. This signal is then fed to a position controller 710 which outputs a signal that is summed with two additional signals.

The feed forward gain signal output by the feed forward gain control operation 712 is summed with the output signal of the position controller 710 along with a motor position feed forward feedback signal that is output by position feed forward derivative operation 714 and is passed through a low pass filter 715 and that is based upon a received motor position feedback signal 705. This signal 705 is received from a high precision rotary sensor mounted on the armature of the motor that is driving a drive roller or drum. The output of the summation is then provided to a low pass filter 720 whose output is then provided to a velocity controller 722.

The feed forward gain signal output by the feed forward gain operation 712 is then provided to a velocity feed forward operation 716 which provides an output to a feed forward gain operation 718 to produce a second feed forward gain signal. The second feed forward gain signal is provided to a current feed forward operation 724 that supplies an output to a feed forward gain operation 726. Additionally, the second feed forward gain signal is summed with the output of the velocity controller 722 and from a web commanded velocity feed forward signal 707 which comes from the trajectory generator. The trajectory generator generates a position reference for each roller's control system, including position and velocity in proper units. The result of summing the velocity feed forward signal 707 with the output of velocity controller 722 is passed through notch and other filters 728 and is summed with the feed forward gain signal as output by the feed forward gain operation 726 and with the actual motor current measurement 709 to provide an input to a current controller 730. The current controller 730 then outputs a current to the motor that is driving a drive roller or drum.

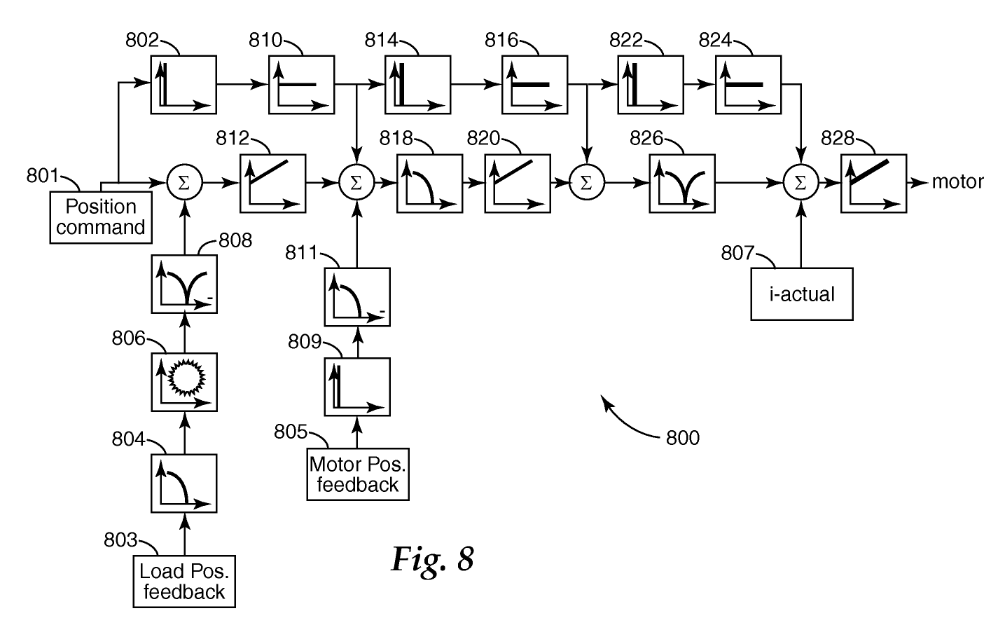

FIG. 8 shows an illustrative guide motor position and velocity control system 800 wherein one of the systems 800 may be used to control the lateral position of the substrate while a second one of the systems 800 may be used to control the lateral position of the mask. The control system 800 receives a position command 801 as input, and this command originates from the sensing system that detects the fiducials indicative of lateral position of the web. This command is provided to a position feed forward operation 802 which then outputs the position feed forward signal to a feed forward gain control operation 810.

The position command 801 is also summed with another signal that is based on a load position feed back signal 803 being provided to a low pass filter operation 804. The load position feed back signal 803 is received on the basis of a high precision linear sensor mounted directly on the web guide frame. The feed forward operation 804 provides an output to observers 806 that use other internal signals to generate an output that is applied to a feedback filtering operation 808 to provide the signal that is negatively summed with the position command 801. This signal is then fed to a position controller 812 which outputs a signal that is summed with two additional signals discussed below.

The feed forward gain signal output by feed forward gain control operation 810 is summed with the position controller output signal 812 along with a motor position feed forward feedback signal that is output by position feed forward derivative operation 809 and passed through a low pass filter 811 and that is based upon a received motor position feedback signal 805. This signal 805 is received on the basis of a high precision rotary sensor mounted directly on the armature of the motor that is moving the web guide frame. The output of the summation is then provided to a low pass filter 818 whose output is then provided to a velocity controller 820.

The feed forward gain signal output by the feed forward gain control operation 810 is then provided to a velocity feed forward operation 814 which provides an output to a feed forward gain operation 816 to produce a second feed forward gain signal. The second feed forward gain signal is provided to a current feed forward operation 822 that supplies an output to a feed forward gain operation 824. Additionally, the second feed forward gain signal is summed with the output of the velocity controller 820. The result is passed through notch and other filters 826 and is summed with the output of the feed forward gain operation 824 and the actual motor current measurement 807 to provide an input to a current controller 828. The current controller 828 then outputs a current to the motor that is moving the web guide frame.

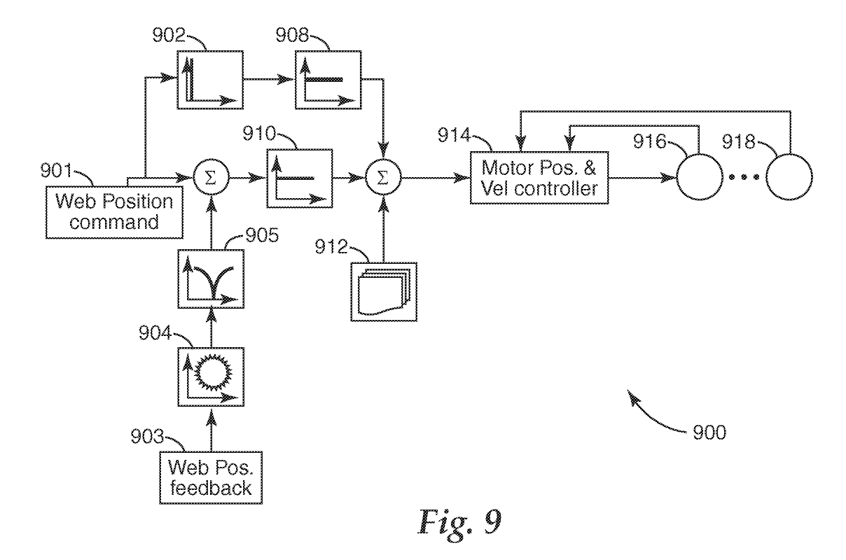

FIG. 9 shows an illustrative web fiducial registration control system 900 that maintains proper registration between the fiducials of the mask with the fiducials of the substrate for stages of the deposition process where fiducials are already present on both webs, such as shown in FIG. 6. The control system 900 receives a web position command 901 as input, and this command originates from a trajectory generator. This command is provided to a position feed forward operation 902 which then outputs the position feed forward signal to a feed forward gain control operation 908.

The position command 901 is also summed with another signal that is based on a web position feed back signal 903. The web position feed back signal 903 is received on the basis of the longitudinal web position. This signal can represent the substrate or mask position, or the difference between them. The web position feedback signal 903 is provided to observers 904 that enhance the position signal generated by the sensor and whose output is applied to a feedback filtering operation 905 to provide the signal summed with the position command 901. The signal resulting from this summation is then fed to a position controller 910 which outputs a signal that is summed with two additional signals as will be described in the following paragraph.

The feed forward gain signal output by the feed forward gain control operation 908 is summed with the signal output by the position controller 910 along with a web feed forward open loop position compensation signal 912 that comes from the trajectory generator. The output of the summation is a guide position command that is then provided to the web position controller shown in FIG. 7. The motor position and velocity is obtained from the motor 916 and a corresponding feedback signal 918 is provided to the motor position and velocity controller 914. The motor position and velocity controller 914 includes a sensor position offset compensation with line speed control.

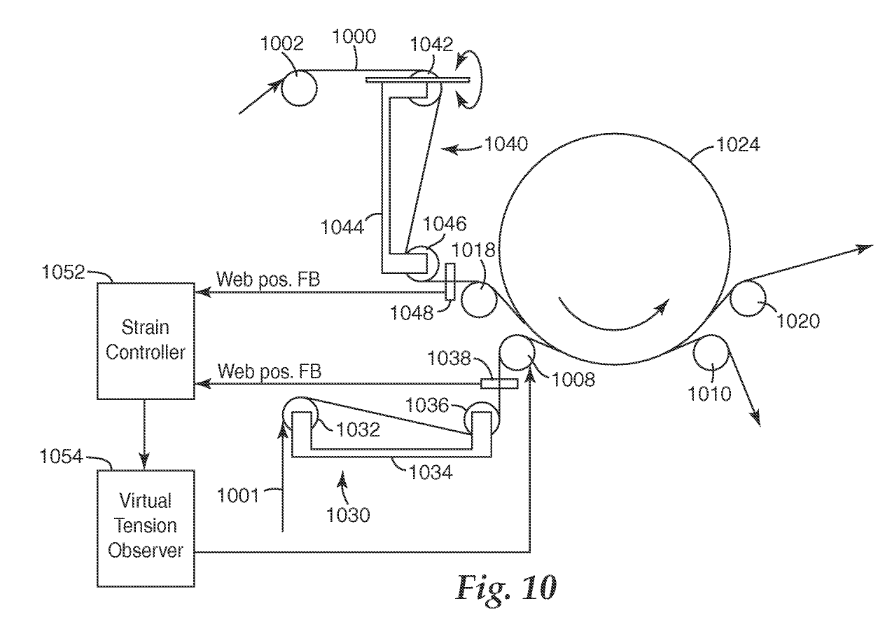

FIG. 10 shows a portion of one illustrative embodiment where the fiducial registration is maintained between the mask and the substrate to allow for the desired feature size of 100 microns or less and a registration tolerance to dimensions of less than 100 microns, less than 50 microns, or even less than 25 microns. The substrate 1000 passes by delivery roller 1002 and then passes through web guide 1040 having rollers 1042 and 1046 mounted to frame 1044. Then, the substrate passes by the sensor 1048 that detects the longitudinal and/or lateral web position. The drive roller 1018 makes final corrections to the elongation and velocity of the substrate 1000 as it travels onto the portion of the circumference of the drum 1024 and then exit roller 1020 directs the substrate 1000 on to a next destination.

The mask 1001 enters a web guide 1030 having rollers 1032 and 1036 mounted to a frame 1034. The mask 1001 passes a sensor 1038 that detects the longitudinal and/or lateral web position, and the drive roller 1008 makes final corrections to the elongation and velocity of the mask 1001 as it travels onto the portion of the circumference of the drum 1024 while the exit roller 1010 directs the mask 1001 away from the drum 1024.

During operation, the substrate sensor 1048 and the mask sensor 1038 output web position feedback signals to a strain controller 1052. The strain controller then generates an output signal to a virtual tension observer 1054. A virtual tension observer is a control system technique wherein the value of one variable is estimated based upon known values of other variables. Observers improve control system performance by reducing a variable's measurement lag, increasing its accuracy, or providing the value of a variable that is difficult or impossible to measure directly. The virtual tension observer 1054 then calculates the tension of the webs based on the position feedback provided to the strain controller 1052 and the material parameters for the substrate and the mask, and generates the proper tension setpoints to upstream controllers, as wells as additional corrective position command offsets that may be added to either drive roller. The virtual tension observer is able to estimate changing parameters in real time. Additional details of the virtual tension observer of this embodiment can be found in commonly owned U.S. Patent Application Publication 2005/0137,738 A1. The virtual tension observer 1054 then provides a drive signal to the motor of the driver roller 1008.

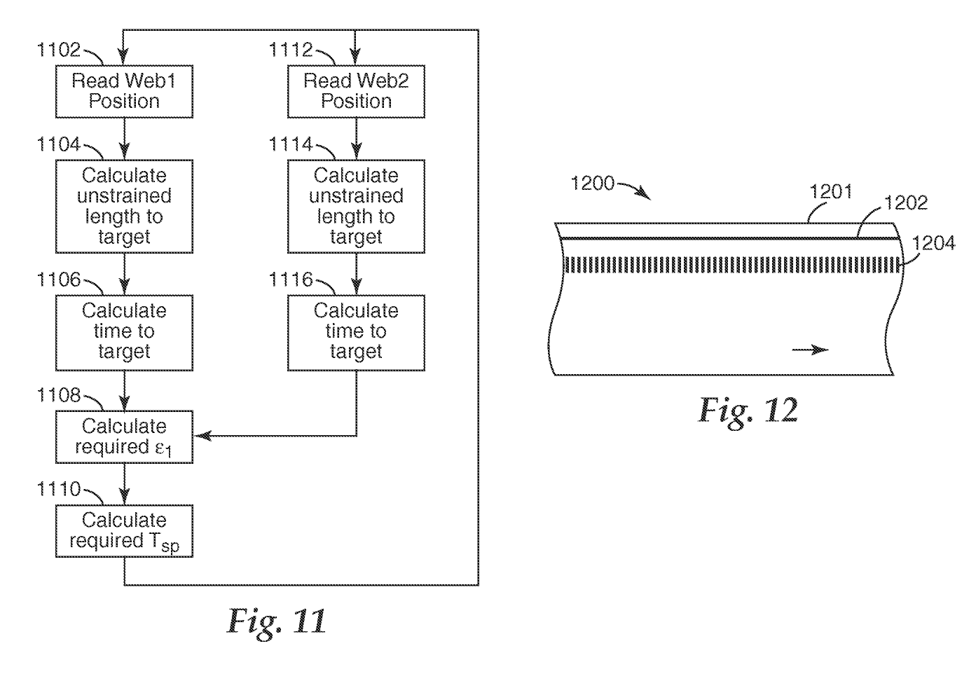

FIG. 11 shows the control loop used by the strain controller 1052 in conjunction with the virtual tension observer 1054. The position of the substrate is read from sensor output at position operation 1102 while the position of the mask is read from sensor output at position operation 1112. The unstrained length to target for the substrate is calculated at calculation operation 1104 while the unstrained length to target for the mask is calculated at calculation operation 1114. The time to target for the substrate is calculated for the substrate at calculation operation 1106 while the time to target for the mask is calculated at calculation operation 1116. Based on the time to target, a new ε₁ value is calculated at calculation operation 1108, where this value represents desired strain in the web. Based on the new ε₁ a required Tₛₚ is calculated at calculation operation 1110, where this value represents the tension required to establish the level of strain

FIG. 12 shows an example of the fiducial markings or pattern elements that may be located on the substrate and the mask for purposes of controlling the lateral and longitudinal positions and maintaining proper registration between the two webs. As discussed above, these fiducial markings may be pre-patterned or may be added to the web during a first stage of the deposition process.

As shown in this example, the lateral or crossweb fiducial may be a line 1202 that is a fixed distance from deposition patterns to be located on the substrate or mask 1200. An edge 1201 of the web 1200 may not be located in a precise relationship to the crossweb fiducial line 1202 or any deposition patterns on the web 1200. From sensing the location of the line 1202 in the lateral direction, it can be determined whether the web 1200 is in the proper location or whether a web guide adjustment is necessary to realign the web in the lateral direction.

As is also shown in this example, the longitudinal or machine direction fiducial may be a series of marks 1204 spaced a fixed distance from one another in the machine direction. From sensing the position of a mark 1204 in the series, it can be determined whether the web 1200 is at the proper longitudinal position relative to deposition patterns on the web 1200 at a given point in time.

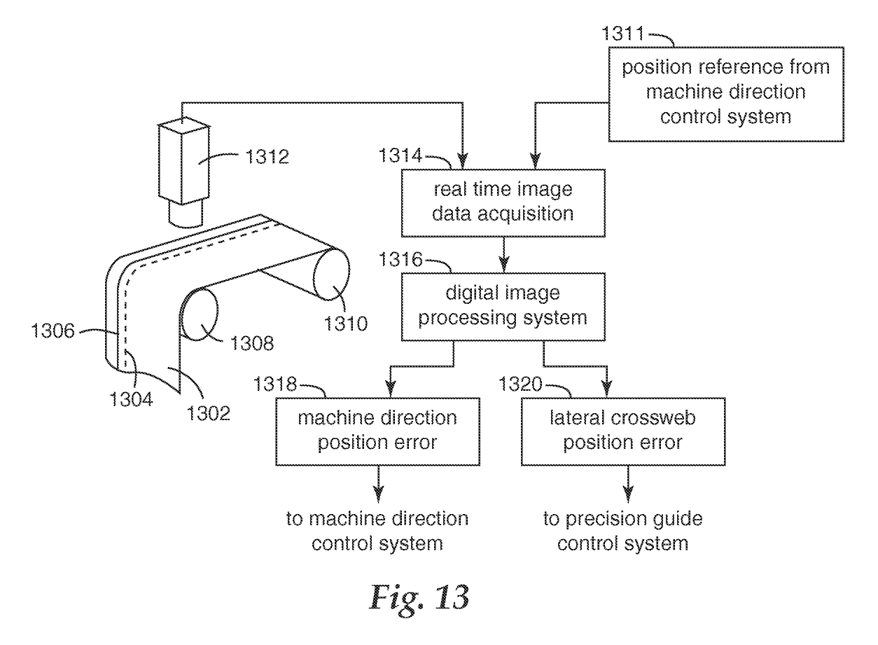

FIG. 13 shows one illustrative embodiment of the sensing system for a web. In this embodiment, a single sensor is being used for both the lateral and the longitudinal directions. The web 1302 has the longitudinal fiducial markings 1304 and the lateral fiducial markings 1306. As the web 1302 passes between a roller 1308 and a roller 1310, a sensor 1312 senses both the longitudinal fiducial markings 1304 and the lateral fiducial marking 1306. The sensor 1312 may be a line scan or area camera.

The sensor 1312 output is directed to a real time image data acquisition process 1314. In addition to receiving the sensor output, the real time image data acquisition process 1314 of this embodiment also receives a position reference 1311 from the longitudinal control system for the web being sensed that synchronizes the capture of the position of the fiducial mark image. The real time image data acquisition process directs the output of a digital image to a digital image processing system 1316. The digital image processing system 1316 analyzes the image to determine how far the lateral and longitudinal marks are from their expected locations. The position error 1318 for the longitudinal or machine direction is output to the longitudinal direction control system for the web being sensed while the position error 1320 for the lateral or crossweb direction is output to the web guide control system.

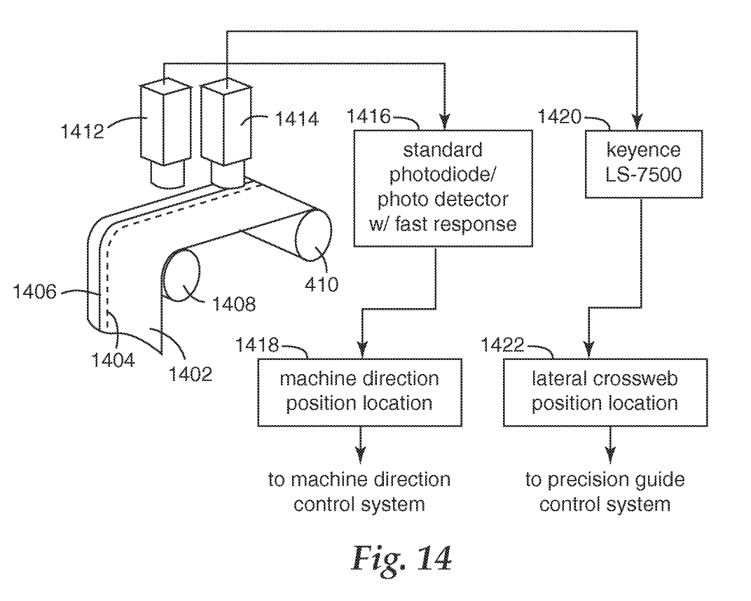

FIG. 14 shows another illustrative embodiment of the sensing system for a web. In this embodiment, one sensor is being used for the lateral direction while another sensor is being used for the longitudinal direction. The web 1402 has the longitudinal fiducial markings 1404 and the lateral fiducial markings 1406. As the web 1402 passes between a roller 1408 and a roller 1410, one sensor 1412 senses the longitudinal fiducial markings 1404 while another sensor 1414 senses the lateral fiducial marking 1406. The sensor 1412 used for the longitudinal sensing may be a standard light emitting diode (LED)/photodiode with a photo detector circuit with a fast response time. The sensor 1414 used for the lateral sensing may be a camera such as a Keyence LS-7500 series CCD camera with built-in high speed processing.

The output from the sensor 1412 is provided to the photodetector circuit 1416 where the fiducial may be observed and where it may be determined how far the actual location of the longitudinal fiducial marking is from the expected location. The position error 1418 for the longitudinal or machine direction is output to the longitudinal direction control system for the web being sensed.

The output from the sensor 1414 is provided to the image processing 1420 of the camera where it may be determined how far the actual location of the lateral fiducial marking is from the expected location. The position error 1422 for the lateral or crossweb direction is output to the web guide control system.

In another aspect, a method of continuously depositing material is provided using the apparatus described above. The method involves continuously delivering a substrate from a substrate delivery roller while continuously receiving the substrate onto a first substrate receiving roller, wherein the substrate passes over a portion of a circumference of a first drum when between the substrate delivery roller and the first substrate receiving roller. The method further involves while continuously delivering and receiving the substrate, continuously delivering a first mask from a first mask delivery roller while continuously receiving the first mask onto a first mask receiving roller, wherein the first mask passes over a portion of a circumference of the first drum when between the first mask delivery roller and the first mask receiving roller and wherein the first mask has a plurality of apertures forming a first pattern and at least a portion of the apertures have a least dimension of 100 microns or less. Additionally, the method involves while continuously delivering and receiving the substrate and the first mask, continuously directing a first deposition material from a first deposition source toward a portion of the first mask that is over the portion of the circumference of the first drum such that the first pattern of first material is deposited on the substrate.

The method can further involve continuously delivering the substrate from the first substrate receiving roller while continuously receiving the substrate onto a second substrate receiving roller, wherein the substrate passes over a portion of a circumference of a second drum when between the first substrate receiving roller and the second substrate receiving roller. The method still further involves continuously delivering a second mask from a second mask delivery roller while continuously receiving the second mask onto a second mask receiving roller, wherein the second mask passes over a portion of a circumference of the second drum when between the second mask delivery roller and the second mask receiving roller and wherein the second mask has a plurality of apertures forming a second pattern. Additionally, the method involves while continuously delivering and receiving the substrate and the second mask, continuously directing a second deposition material from a second deposition source toward a portion of the second mask that is over the portion of the circumference of the second drum such that the second pattern of second deposition material is deposited on the substrate.

While the invention has been particularly shown and described with reference to various embodiments thereof, it will be understood by those skilled in the art that various other changes in the form and details may be made therein without departing from the spirit and scope of the invention.

What is claimed is:

1. An apparatus for continuously depositing a pattern of material on a substrate, comprising:
a substrate delivery roller from which the substrate is delivered;
a first substrate receiving roller upon which the substrate is received such that the substrate extends from the substrate delivery roller to the substrate receiving roller, the substrate continuously passing from the substrate delivery roller to the substrate receiving roller;
a first mask containing apertures defining a first pattern, wherein one or more of the apertures have a least dimension of 100 microns or less;
a first mask delivery roller from which the first mask is delivered;
a first mask receiving roller upon which the first mask is received such that the mask extends from the mask delivery roller to the mask receiving roller, the first mask continuously passing from the first mask delivery roller to the first mask receiving roller;
a first drum upon which the substrate and first mask come into contact over a portion of the circumference of the first drum between delivery from the substrate and mask delivery roller and reception onto the substrate and mask receiving rollers, the first drum continuously rotating; and
a first deposition source positioned to continuously direct first deposition material toward the portion of the first mask that is over the portion of the circumference of the first drum such that at least a portion of the first deposition material passes through the apertures of the first mask to continuously deposit the first pattern of the first material on the substrate.

2. The apparatus of claim 1, wherein the first mask is a polymeric mask.

3. The apparatus of claim 1, wherein the one or more of the apertures of the first mask have a least dimension of 10 microns or less.

4. The apparatus of claim 1, further comprising:
a first substrate elongation control system that maintains a pre-determined elongation of the substrate in the direction of delivery from the substrate delivery roller to the first drum as the substrate comes into contact over a portion of the circumference of the first drum; and
a first mask elongation control system that maintains a pre-determined elongation of the first mask in the direction of delivery from the first mask delivery roller to the first drum as the first mask comes into contact over a portion of the circumference of the first drum.

5. The apparatus of claim 1, further comprising:
a first substrate transverse position control system including a web guide that adjusts the transverse position of the substrate to a pre-determined transverse location on the first drum; and
a first mask transverse position control system including a web guide that adjusts the transverse position of the first mask to a pre-determined transverse location on the first drum.

6. The apparatus of claim 4, further comprising:
a first substrate transverse position control system including a web guide that adjusts the transverse position of the substrate to a pre-determined transverse location on the first drum; and
a first mask transverse position control system including a web guide that adjusts the transverse position of the first mask to a pre-determined transverse location on the first drum,
wherein the first mask further comprises pattern elements, the apparatus further comprising at least one mask sensor, the at least one mask sensor generating a signal based on sensing the pattern elements of the first mask, the at least one mask sensor being utilized by the first mask elongation control system and the first mask transverse position control system.

7. The apparatus of claim 6, wherein the substrate comprises pattern elements, the apparatus further comprising at least one substrate sensor, the at least one substrate sensor generating a signal based on sensing the pattern elements of the substrate, the at least one substrate sensor being utilized by the substrate elongation control system and the substrate transverse position control system.

8. The apparatus of claim 1, wherein the substrate is in direct contact with the first drum over the portion of the circumference of the first drum, wherein the first mask is in direct contact with the substrate over the portion of the circumference of the first drum, and wherein the first deposition source is positioned at a location exterior to the first drum such that the first mask is located between the substrate and the first deposition source.

9. The apparatus of claim 1, wherein the first drum includes apertures spaced about the circumference, wherein the first mask is in direct contact with the first drum and spans the apertures over the portion of the circumference of the first drum, wherein the substrate is in direct contact with the first mask over the portion of the circumference of the first drum, and wherein the first deposition source is positioned on the interior of the first drum such that the first mask is located between the substrate and the first deposition source.

10. The apparatus of claim 1, further comprising:
a second mask containing apertures defining a second pattern, wherein one or more of the apertures have a least dimension of 100 microns or less;
a second mask delivery roller from which the second mask is delivered;
a second mask receiving roller upon which the second mask is received such that the second polymeric mask extends from the mask delivery roller to the mask receiving roller, the second mask continuously passing from the second mask delivery roller to the second mask receiving roller;
a second substrate receiving roller upon which the substrate is received, the substrate continuously passing from the first substrate receiving roller to the second substrate receiving roller;
a second drum upon which the substrate and the second mask come into contact over a portion of the circumference of the second drum, the second drum receiving the substrate between the substrate receiving roller and the second substrate receiving roller, the second drum continuously rotating; and
a second deposition source positioned to continuously direct second deposition material toward a portion of the second mask that is over the portion of the circumference of the second drum such that at least a portion of the second deposition material passes through the apertures of the second mask to deposit the second pattern of the second material onto the substrate.

11. The apparatus of claim 10, further comprising:
a second substrate elongation control system that maintains a pre-determined elongation of the substrate in the direction of delivery from the substrate receiving roller to the second drum as the substrate comes into contact over a portion of the circumference of the second drum; and
a second mask elongation control system that maintains a pre-determined elongation of the second mask in the direction of delivery from the second mask delivery roller to the second drum as the second mask comes into contact over a portion of the circumference of the second drum.

12. The apparatus of claim 10, further comprising:
a second substrate transverse position control system including a web guide that adjusts the transverse position of the substrate to a pre-determined transverse location on the second drum; and
a second mask transverse position control system including a web guide that adjusts the transverse position of the second mask to a pre-determined transverse location on the second drum.

13. The apparatus of claim 11, wherein the second mask includes pattern elements, wherein apertures of the first mask cause the material from the first deposition source to be deposited onto the substrate to form pattern elements, and wherein the second mask elongation control system comprises a sensor that produces a signal by sensing the pattern elements of the substrate and the signal is utilized by the second mask elongation control system to adjust the pre-defined elongation of the second mask to maintain proper alignment of the pattern elements of the second mask with the pattern elements of the substrate in the direction of delivery of the second mask between the second mask delivery roller and the second drum.

14. The apparatus of claim 10, wherein the substrate is in direct contact with the second drum, wherein the second mask is in direct contact with the substrate, and wherein the second deposition source is positioned at a location exterior to the second drum such that the second mask is located between the substrate and the second deposition source.

15. The apparatus of claim 10, wherein the second drum includes apertures spaced about the circumference, wherein the second mask is in direct contact with the second drum and spans the apertures of the second drum, wherein the substrate is in direct contact with the second mask, and wherein the second deposition source is positioned on the interior of the second drum such that the second mask is located between the substrate and the second deposition source.

16. The apparatus of claim 10, wherein the second mask is polymeric.

17. The apparatus of claim 10, wherein the least dimension of the one or more apertures of the second mask is 10 microns or less.

18. The apparatus of claim 4, wherein the first substrate elongation control system and the first mask elongation control system operate to maintain a registration tolerance between the substrate and the mask to less than 50 microns.

19. An apparatus for continuously depositing a pattern of material on a substrate, comprising:
a substrate delivery roller from which the substrate is delivered;
a first substrate receiving roller upon which the substrate is received such that the substrate extends from the substrate delivery roller to the substrate receiving roller, the substrate continuously passing from the substrate delivery roller to the substrate receiving roller;
a first mask containing apertures defining a first pattern;
a first mask delivery roller from which the first mask is delivered;
a first mask receiving roller upon which the first mask is received such that the mask extends from the mask delivery roller to the mask receiving roller, the first mask continuously passing from the first mask delivery roller to the first mask receiving roller;
a first drum upon which the substrate and first polymeric mask come into contact over a portion of the circumference of the first drum between delivery from the substrate and mask delivery roller and reception onto the substrate and mask receiving rollers, the first drum continuously rotating;
a first deposition source positioned to continuously direct first deposition material toward the portion of the first mask that is over the portion of the circumference of the first drum such that at least a portion of the first deposition material passes through the apertures of the first mask to continuously deposit the first pattern of the first material on the substrate;
a first substrate elongation control system that maintains a pre-determined elongation of the substrate in the direction of delivery from the substrate delivery roller to the first drum as the substrate comes into contact over a portion of the circumference of the first drum;
a first mask elongation control system that maintains a pre-determined elongation of the first mask in the direction of delivery from the first mask delivery roller to the first drum as the first mask comes into contact over a portion of the circumference of the first drum;
a first substrate transverse position control system including a web guide that adjusts the transverse position of the substrate to a pre-determined transverse location on the first drum; and
a first mask transverse position control system including a web guide that adjusts the transverse position of the first mask to a pre-determined transverse location on the first drum.

20. The apparatus of claim 19, wherein the first mask is polymeric.

21. The apparatus of claim 19, wherein one or more of the apertures has a least dimension of 100 microns or less.

22. The apparatus of claim 21, wherein the first substrate elongation control system and the first mask elongation control system operate to maintain a registration tolerance between the substrate and the mask to less than 50 microns.

24. The apparatus of claim 21, wherein the first substrate transverse position control system and the first mask transverse position control system operate to maintain registration tolerance between the substrate and the mask to less than 50 microns.

25. A method of continuously depositing material, comprising:
continuously delivering a substrate from a substrate delivery roller while continuously receiving the substrate onto a substrate receiving roller, wherein the substrate passes over a portion of a circumference of a first drum when between the substrate delivery roller and the substrate receiving roller;
while continuously delivering and receiving the substrate, continuously delivering a first mask from a first mask delivery roller while continuously receiving the first mask onto a first mask receiving roller, wherein the first mask passes over a portion of a circumference of the first drum when between the first mask delivery roller and the first mask receiving roller and wherein the first mask has a plurality of apertures forming a first pattern and at least a portion of the apertures have a least dimension of 100 microns or less;
while continuously delivering and receiving the substrate and the first mask, continuously directing a first deposition material from a first deposition source toward a portion of the first mask that is over the portion of the circumference of the first drum such that the first pattern of first material is deposited on the substrate.
